(19) United States
(12) Patent Application Publication
(10) Pub. No.: US 2025/0085541 A1
(43) Pub. Date: Mar. 13, 2025

(54) HEAD-UP DISPLAY DEVICE

(71) Applicant: Yazaki Corporation, Tokyo (JP)

(72) Inventors: Naohisa MURATA, Shizuoka (JP); Tomohiro MIYAZAWA, Shizuoka (JP)

(73) Assignee: Yazaki Corporation, Tokyo (JP)

(21) Appl. No.: 18/960,706

(22) Filed: Nov. 26, 2024

Related U.S. Application Data
(63) Continuation of application No. PCT/JP2023/035223, filed on Sep. 27, 2023.

(30) Foreign Application Priority Data
Sep. 29, 2022 (JP) 2022-155992

(51) Int. Cl. G02B 27/01; G02B 27/09

(52) U.S. Cl. CPC G02B 27/0101; G02B 27/0983; G02B 2027/011; G02B 2027/013

(57) ABSTRACT

In a head-up display device, a transparent cover closes an opening, and transmits enlarged display light. In the opening, a facing portion that blocks light is erected on the side opposite to the side of an eye point of the opening. The transparent cover includes a curved portion. The curved portion has an inner surface portion that is located on the side of the reflection mirror, and an outer surface portion that is located on the side opposite to the side of the reflection mirror and that collects external light onto the facing portion. Then, the thickness between the inner surface portion and the outer surface portion in a third direction is thickened from the side of the facing portion toward the side of the eye point in a range on the side of the eye point from a lowest point of the transparent cover in the third direction.

### CROSS-REFERENCE TO RELATED APPLICATION(S)

This application is a continuation application of International Application No. PCT/JP2023/035223 filed on Sep. 27, 2023 which claims the benefit of priority from Japanese Patent Application No. 2022-155992 filed on Sep. 29, 2022 and designating the U.S., the entire contents of which are incorporated herein by reference.

### BACKGROUND OF THE INVENTION

### 1. Field of the Invention

The present invention relates to a head-up display device.

### 2. Description of the Related Art

For example, Japanese Patent Application Laid-open No. 2006-91104 describes, as a conventional head-up display device, a vehicle head-up display that displays a virtual image via a front windshield of a vehicle. The vehicle head-up display includes a housing that is disposed in an instrument panel of a vehicle, and that has an opening that emits image light of an image, a display instrument that is housed in the housing, and that emits the image light of the image; a magnifier that is housed in the housing, and enlarges and that reflects an image directly incident from the display instrument, and a lens that closes the opening of the housing, that enlarges the image incident from the magnifier, and that outputs the image to the front windshield.

Meanwhile, the above-described vehicle head-up display device described in Japanese Patent Application Laid-open No. 2006-91104 is desired to inhibit external light reflected by the lens from reaching an eye point of an occupant, for example.

### SUMMARY OF THE INVENTION

Thus, the present invention has been made in view of the above, and an object thereof is to provide a head-up display device capable of properly displaying a virtual image.

In order to achieve the above mentioned object, a head-up display device according to one aspect of the present invention includes a display unit that is provided in a vehicle and that displays a virtual image by reflecting display light emitted toward a reflection member capable of transmitting light toward a side of an eye point with the reflection member; and a housing which has an opening facing the reflection member and to which the display unit is assembled, wherein the display unit includes: a display instrument that is housed inside the housing and that emits the display light; a reflection mirror that is housed inside the housing and that reflects enlarged display light obtained by enlarging the display light emitted from the display instrument toward the reflection member through the opening; and a transparent cover that closes the opening and that transmits the enlarged display light reflected by the reflection mirror, in the opening, a facing portion that blocks light is erected on a side opposite to the side of the eye point of the opening, the transparent cover includes a curved portion having a curved shape, the curved portion includes: a first surface portion located on a side of the reflection mirror; and a second surface portion that is located on a side opposite to the side of the reflection mirror and that collects external light onto the facing portion, a thickness between the first surface portion and the second surface portion in a vertical direction is thickened from a side of the facing portion toward the side of the eye point in a range on the side of the eye point from a lowest point of the transparent cover in the vertical direction, and the lowest point of the transparent cover enters the lower side of the facing portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view illustrating a configuration example of a head-up display device according to an embodiment;

FIG. 2 is a perspective view illustrating a configuration example of a transparent cover according to the embodiment;

FIG. 3 is a schematic view illustrating a relation between reflection of external light and an eyellipse according to the embodiment;

FIG. 4 is a schematic view illustrating an example of reflection of external light according to a comparative example; and

FIG. 5 is a schematic view illustrating an example of reflection of external light according to the embodiment.

### DETAILED DESCRIPTION OF THE PREFERRED EMBODIMENTS

An embodiment for carrying out the present invention (embodiment) will be described in detail with reference to the drawings. The present invention is not limited to the contents described in the following embodiment. Furthermore, the components described below include those that can be easily assumed by a skilled person and those that are substantially the same. Moreover, the configurations described below can be appropriately combined. Furthermore, various omissions, substitutions, or changes of a configuration can be made without departing from the gist of the present invention.

### Embodiment

A head-up display device 1 according to an embodiment will be described with reference to the drawings. The head-up display device 1 is provided in a vehicle, and displays a virtual image S by reflecting display light L1 emitted toward a window shield WS capable of transmitting light toward a side of an eye point EP with the window shield WS. Here, the window shield WS is an example of a reflection member. The window shield WS is a plate-shaped member formed of transparent glass. The window shield WS is provided in front of a driver seat to block wind. The head-up display device 1 may be an AR-HUD device or an HUD device. The AR-HUD device superimposes and displays the virtual image S on an object (e.g., person, sign, another vehicle, and so on) in front of the vehicle. The HUD device displays the virtual image S without superimposing the virtual image S on the object in front of the vehicle. The head-up display device 1 will be described in detail below.

Here, a direction along a vehicle width direction of the vehicle is referred to as a first direction X. A direction along an entire length direction of the vehicle is referred to as a second direction Y. A direction along an up-and-down direction of the vehicle is referred to as a third direction Z. The second direction Y can also be said to be along a straight traveling direction in which the vehicle travels straight. The third direction Z can also be said to be along a vertical direction. The first direction X, the second direction Y, and the third direction Z intersect each other, and are typically orthogonal to each other. Note that the first direction X and the second direction Y can also be said to be along a horizontal plane orthogonal to the vertical direction.

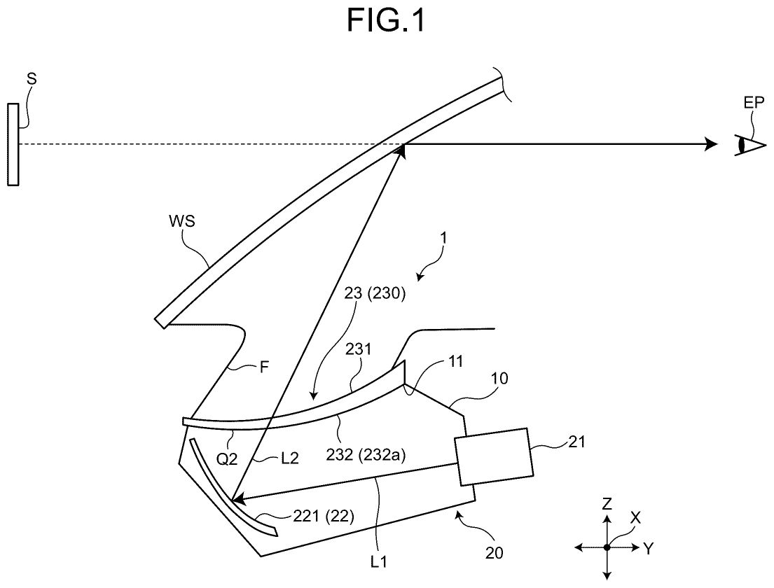

As illustrated in FIG. 1, the head-up display device 1 includes a housing 10 and a display unit 20.

The housing 10 is provided in the vehicle, and the display unit 20 is assembled thereto. The housing 10 has a box shape, and houses a display instrument 21 and a reflection mirror 22 of the display unit 20 to be described later inside the housing 10. The housing 10 has an opening 11 that causes the inside and the outside to communicate with each other. The opening 11 is a portion provided to face the window shield WS and capable of transmitting light.

The display unit 20 displays the virtual image S by reflecting the display light L1 emitted toward the window shield WS toward the side of the eye point EP with the window shield WS. The display unit 20 includes the display instrument 21, the reflection mirror 22, and a transparent cover 23.

The display instrument 21 emits the display light L1 including an image, and is housed inside the housing 10. The display instrument 21 includes, for example, a display and a backlight. The display forms an image, and includes, for example, a thin film transistor-liquid crystal display (TFT-LCD). The backlight applies light toward the back surface of the display, and includes, for example, a plurality of light-emitting diodes (LEDs). The display instrument 21 emits the display light L1 including an image from the display toward the reflection mirror 22 by applying light toward the display with the backlight. For example, the display instrument 21 directly emits the display light L1 toward the reflection mirror 22 without using another mirror. That is, no optical component is interposed between the display instrument 21 and the reflection mirror 22.

Note that, in the example, in the display instrument 21, a part of the display instrument 21 is housed inside the housing 10, and the other part of the display instrument 21 is exposed to the outside of the housing 10. Specifically, in the display instrument 21, an emission portion (e.g., display) that emits the display light L1 is housed inside the housing 10, and a portion (e.g., backlight) other than the emission portion of the display instrument 21 is exposed to the outside of the housing 10.

The reflection mirror 22 totally reflects light, and is housed inside the housing 10. The reflection mirror 22 has a reflection surface 221 formed in a recessed and aspherical shape. The reflection surface 221 is disposed to face the display instrument 21, and is disposed to face the transparent cover 23. The reflection mirror 22 enlarges the display light L1 (image) emitted from the display instrument 21 with the reflection surface 221, and reflects enlarged display light L2 obtained by the enlargement toward the window shield WS through the opening 11 (transparent cover 23) of the housing 10. Specifically, the reflection mirror 22 enlarges the display light L1 directly emitted from the display instrument 21 with the reflection surface 221 without using another mirror, and reflects the enlarged display light L2 obtained by the enlargement toward the window shield WS through the opening 11 (transparent cover 23) of the housing 10.

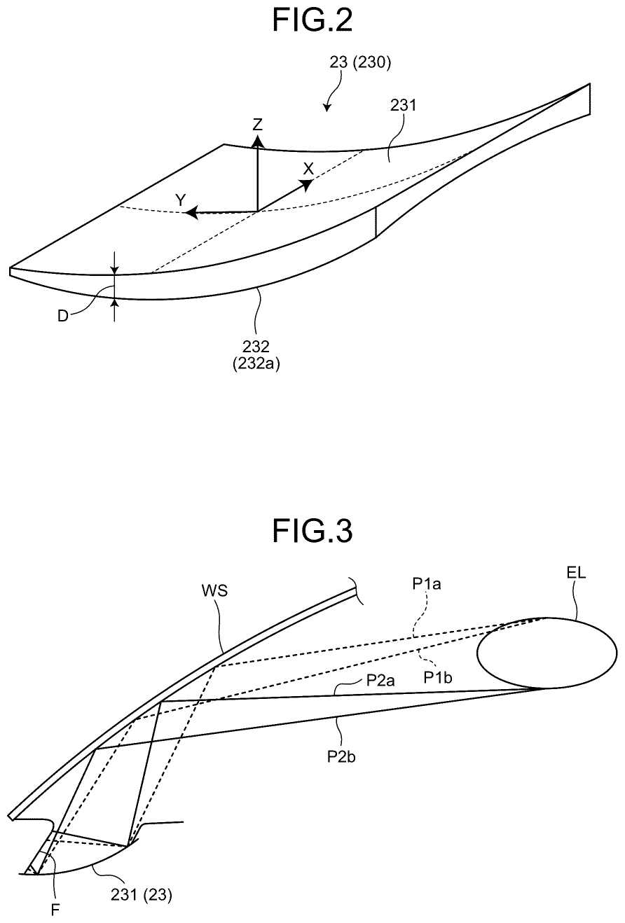

The transparent cover 23 closes the opening 11 of the housing 10, and transmits light. The transparent cover 23 is a curved plate formed of transparent resin, and closes the opening 11. The transparent cover 23 includes a curved portion 230 having a shape of a curve toward the inside of a housing 2. That is, the curved portion 230 has a shape of a recess toward the inside of the housing 2. As illustrated in FIG. 2, the curved portion 230 has an outer surface portion 231 and an inner surface portion 232. The outer surface portion 231 serves as a second surface portion. The inner surface portion 232 serves as a first surface portion.

The outer surface portion 231 is located on the side opposite to the side of the reflection mirror 22, and is formed to be curved toward the inside of the housing 2. That is, the outer surface portion 231 is provided on the side of the window shield WS. The outer surface portion 231 reflects external light toward a facing portion F. Here, the facing portion F blocks light, and is erected on the side opposite to the side of the eye point EP of the opening 11. That is, the facing portion F is a wall portion extending along the third direction Z on the side opposite to the side of the eye point EP of the transparent cover 23. In the example, the facing portion F is slightly inclined toward the side of the transparent cover 23. The outer surface portion 231 has a shape in which external light incident from the outside of the housing 2 is reflected toward the facing portion F. Specifically, the outer surface portion 231 has a linear XZ cross section without being curved, taken along the first direction X and the third direction Z. Furthermore, the outer surface portion 231 has a curved YZ cross section taken along the second direction Y and the third direction Z, and has a curved shape with a curvature at which external light can be reflected toward the facing portion F. The outer surface portion 231 reflects external light incident from the outside of the housing 2 toward the facing portion F. For example, as illustrated in FIG. 3, the outer surface portion 231 reflects, toward the facing portion F, beams of external light P1a and P1b, which have traveled from the side of the upper end of an eyellipse EL in the third direction Z toward the window shield WS and have been reflected toward the side of the transparent cover 23 by the window shield WS. Furthermore, the outer surface portion 231 reflects, toward the facing portion F, beams of external light P2a and P2b, which have traveled from the side of the lower end of the eyellipse EL in the third direction Z toward the window shield WS and have been reflected toward the side of the transparent cover 23 by the window shield WS. Note that the eyellipse EL is a predetermined space region, and is a region preliminarily assumed as a region in which the positions of driver eyes are distributed.

The inner surface portion 232 is located on the side of the reflection mirror 22, and is curved toward the inside of the housing 2. That is, the inner surface portion 232 is provided on the side opposite to the side of the window shield WS. The inner surface portion 232 has a free curved surface 232a. Like a sphere, a cylinder, and the like, the free curved surface 232a cannot be represented by a simple mathematical expression. For example, the free curved surface 232a is expressed by setting a plurality of intersections and curvatures in space and interpolating each of the intersections with a high-order polynomial. The free curved surface 232a has a shape in which the aberration of the virtual image S caused by an optical member including the window shield WS and the like is corrected. The free curved surface 232a has a shape in which the aberration of the virtual image S caused by the shape of the window shield WS is corrected, for example. The transparent cover 23 performs aberration correction on the enlarged display light L2 reflected by the reflection mirror 22 by using the free curved surface 232a. Then, the transparent cover 23 emits the corrected and enlarged display light L2 subjected to the aberration correction using the free curved surface 232a toward the window shield WS. The corrected and enlarged display light L2 emitted toward the window shield WS is reflected toward the side of the eye point EP by the window shield WS, and guided to the eye point EP.

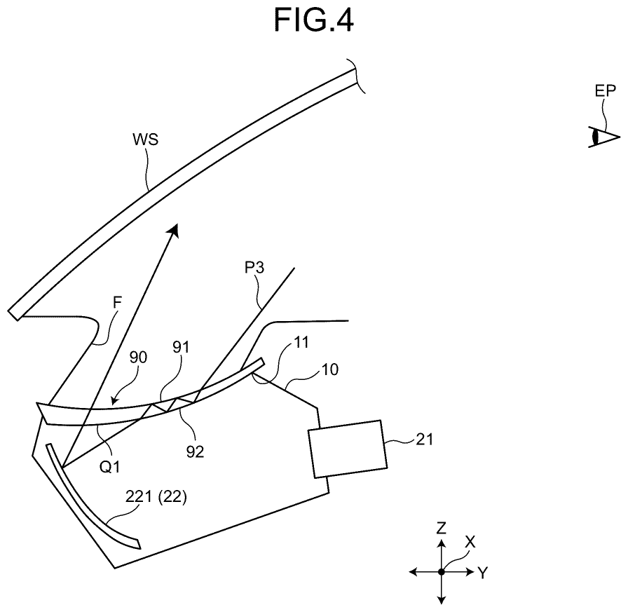

Here, as illustrated in FIG. 4, a transparent cover 90 according to a comparative example has a thickness between an inner surface portion 92 and an outer surface portion 91 in the third direction Z, thinned from the side of the facing portion F toward the side of the eye point EP in a range on the side of the eye point EP from a lowest point Q1 of the transparent cover 90 in the third direction Z. Therefore, when external light P3 is incident on the transparent cover 90 and propagates inside the transparent cover 90, the transparent cover 90 according to the comparative example relatively increases an incident angle of the external light P3. Therefore, the transparent cover 90 increases the reflectance of the external light P3, which causes the external light P3 to be reflected many times and easily propagated. The external light P3 thus easily travels in the direction of the reflection mirror 22. Thus, in the comparative example, the external light P3, which has been reflected inside the transparent cover 90, transmitted through the transparent cover 90, and emitted toward the reflection mirror 22, tends to be reflected toward the position of the opening 11 on the side of the upper end of the reflection mirror 22 in the third direction Z. In the comparative example, this causes a problem of the external light P3 being guided to the eye point EP after being reflected inside the transparent cover 23 and the external light P3 generating ghost.

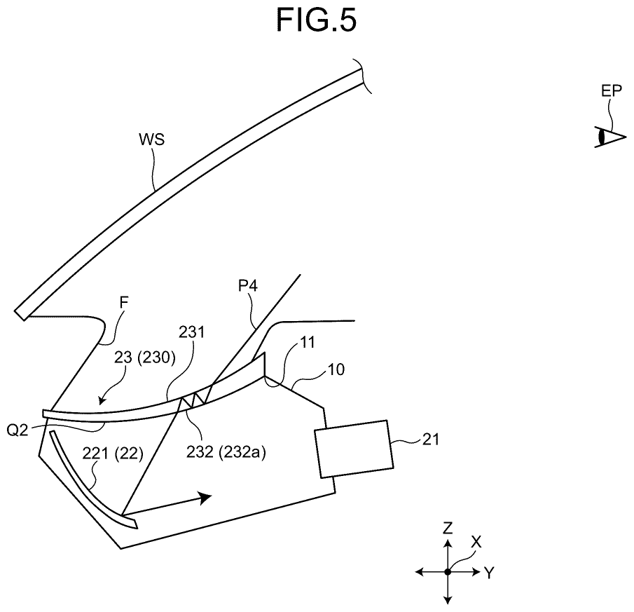

In contrast, as illustrated in FIG. 5, the transparent cover 23 according to the embodiment has a thickness D (see FIG. 2) between the inner surface portion 232 and the outer surface portion 231 in the third direction Z, thickened from the side of the facing portion F toward the side of the eye point EP in a range on the side of the eye point EP from a lowest point Q2 of the transparent cover 23 in the third direction Z. That is, the transparent cover 23 has a YZ cross section taken along the second direction Y and the third direction Z, in which the distance between the inner surface portion 232 and the outer surface portion 231 in the third direction Z is gradually increased from the side of the facing portion F toward the side of the eye point EP in the range on the side of the eye point EP from the lowest point Q2 of the transparent cover 23. Note that, in the example, the lowest point Q2 of the transparent cover 23 in the third direction Z enters the lower side of the facing portion F in the third direction Z. That is, when viewed from the third direction Z, the lowest point Q2 of the transparent cover 23 overlaps the facing portion F.

This configuration causes the head-up display device 1 according to the embodiment to decrease an incident angle of external light P4 compared to that in the comparative example when the external light P4 is incident on the transparent cover 23 and propagates inside the transparent cover 23, as illustrated in FIG. 5. Therefore, the head-up display device 1 decreases the reflectance of the external light P4, which prevents propagation of the external light P4. The external light P4 thus has difficulty in traveling in the direction of the reflection mirror 22. Furthermore, the head-up display device 1 decreases an incident angle of the external light P4. The external light P4, which has been transmitted through the transparent cover 23 and emitted toward the reflection mirror 22, tends to be reflected toward a position (e.g., side of display instrument 21) different from the position of the opening 11 on the side of the lower end of the reflection mirror 22 in the third direction Z. This enables the head-up display device 1 to inhibit the external light P4 from being guided to the eye point EP after being reflected inside the transparent cover 23, and to inhibit the external light P4 from generating ghost. Furthermore, in the head-up display device 1, the external light P4, which has been reflected inside the transparent cover 23, transmitted through the transparent cover 23, and emitted toward the reflection mirror 22, may be reflected toward the opening 11 on the side of the upper end of the reflection mirror 22 in the third direction Z. In this case, the head-up display device 1 can relatively decrease the luminance of the external light P4 since the external light P4 is reflected by the inner surface portion 232 and the outer surface portion 231 with a reflectance smaller than that of the external light P3 of the comparative example. This can inhibit the external light P4 from generating ghost even if the external light P4 is guided to the eye point EP.

As described above, the head-up display device 1 according to the embodiment includes the display unit 20 and the housing 10. The display unit 20 is provided in the vehicle, and displays the virtual image S by reflecting the display light L1 emitted toward the window shield WS capable of transmitting light toward the side of the eye point EP with the window shield WS. The housing 10 has the opening 11 facing the window shield WS, and the display unit 20 is assembled thereto. The above-described display unit 20 includes the display instrument 21, the reflection mirror 22, and a transparent cover 23. The display instrument 21 is housed inside the housing 10, and emits the display light L1. The reflection mirror 22 is housed inside the housing 10, and reflects the enlarged display light L2 obtained by enlarging the display light L1 emitted from the display instrument 21 toward the window shield WS through the opening 11. The transparent cover 23 closes the opening 11, and transmits the enlarged display light L2 reflected by the reflection mirror 22. In the opening 11, the facing portion F that blocks light is erected on the side opposite to the side of the eye point EP of the opening 11. The above-described transparent cover 23 includes the curved portion 230 having a curved shape. The curved portion 230 has the inner surface portion 232 and the outer surface portion 231. The inner surface portion 232 is located on the side of the reflection mirror 22. The outer surface portion 231 is located on the side opposite to the side of the reflection mirror 22, and collects external light onto the facing portion F. Then, the thickness D between the inner surface portion 232 and the outer surface portion 231 in the third direction Z is thickened from the side of the facing portion F toward the side of the eye point EP in the range on the side of the eye point EP from the lowest point Q2 of the transparent cover 23 in the third direction Z.

This configuration enables the head-up display device 1 to collect external light reflected by the outer surface portion 231 onto the facing portion F. Furthermore, since the head-up display device 1 has the thickness D of the transparent cover 23, thickened from the side of the facing portion F toward the side of the eye point EP, the head-up display device 1 can relatively decrease the reflectance of external light reflected by the inner surface portion 232 and the outer surface portion 231. This enables the head-up display device 1 to relatively decrease the luminance of the external light P4 reflected inside the transparent cover 23. The external light P4 can be inhibited from being visually recognized as ghost even if the external light P4 reflected inside the transparent cover 23 reaches the eye point EP. This enables the head-up display device 1 to properly display the virtual image S.

In the head-up display device 1, the inner surface portion 232 has the free curved surface 232a used for performing aberration correction on the enlarged display light L2 reflected by the reflection mirror 22. This configuration enables the head-up display device 1 to correct the aberration of the virtual image S with the free curved surface 232a of the transparent cover 23. The virtual image S is generated by an optical member including the window shield WS and the like. Then, in the head-up display device 1, the transparent cover 23 mainly carries a function of aberration correction, and the reflection mirror 22 mainly carries an enlargement function. The role sharing can improve the accuracy of aberration correction, and improve an enlargement ratio. The head-up display device 1 can be easily manufactured by role sharing that reduces the number of parameter coefficients, which can decrease tolerance. In the head-up display device 1, an increase in the number of components can be inhibited and an increase in size of an optical system can be inhibited by the transparent cover 23 that closes the opening 11 of the housing 10 also having the function of aberration correction. As a result, the head-up display device 1 can properly display the virtual image S.

The display instrument 21 in the head-up display device 1 directly emits the display light L1 toward the reflection mirror 22. The reflection mirror 22 reflects the enlarged display light L2 obtained by enlarging the display light L1 directly emitted from the display instrument 21 toward the window shield WS via the transparent cover 23. This configuration causes the display instrument 21 in the head-up display device 1 to directly emit the display light L1 toward the reflection mirror 22 without using another mirror, so that the size of the device can be reduced.

### Modification

Next, a modification of the embodiment will be described. Note that, in the modification, the same reference sign is attached to a component equivalent to that of the embodiment, and detailed description thereof will be omitted. The reflection mirror 22 may reflect the external light P4, which has been reflected by the inner surface portion 232 and the outer surface portion 231 of the transparent cover 23, transmitted through the transparent cover 23, and emitted toward the reflection mirror 22, toward a position different from the position of the opening 11. In this case, even if the reflection mirror 22 cannot reflect the external light P4 toward the position different from the position of the opening 11 and the reflection mirror 22 reflects the external light P4 toward the opening 11, the luminance of the external light P4 can be relatively decreased as described above. The external light P4 can be inhibited from being visually recognized as ghost even when the external light P4 reaches the eye point EP. The head-up display device 1 can inhibit the external light P4 from being visually recognized as ghost more by configuring the reflection mirror 22 such that the external light P4 is reflected toward the position different from the position of the opening 11.

Although an example in which the display instrument 21 directly emits the display light L1 toward the reflection mirror 22 without using another mirror has been described, this is not a limitation. The display light L1 may be indirectly emitted toward the reflection mirror 22 via another mirror.

Although an example in which the free curved surface 232a is formed on the side of the reflection mirror 22 of the transparent cover 23 has been described, this is not a limitation. The free curved surface 232a may be formed on the side opposite to the side of the reflection mirror 22 of the transparent cover 23.

The transparent cover 23 may have a function of enlarging the enlarged display light L2 (image) in addition to a function of correcting the aberration of the virtual image S with the free curved surface 232a. In this case, the transparent cover 23 enlarges the enlarged display light L2 (image) at an enlargement ratio smaller than the enlargement ratio of the reflection mirror 22. For example, the transparent cover 23 enlarges the enlarged display light L2 (image) at an enlargement ratio approximately 1/10 smaller than the enlargement ratio of the reflection mirror 22.

The reflection mirror 22 may have a function of correcting the aberration of the virtual image S with the reflection surface 221 in addition to a function of enlarging the display light L1 (image). In this case, the reflection mirror 22 corrects the aberration of the virtual image S in an amount of aberration correction smaller than that of the transparent cover 23. For example, the reflection mirror 22 corrects the aberration of virtual image S in an amount of aberration correction approximately 1/10 smaller than that of the transparent cover 23. Although an example in which the reflection member is the window shield WS has been described, this is not a limitation. The reflection member may be, for example, a combiner or the like.

The transparent cover 23 may have the outer surface portion 231 and the inner surface portion 232 having a Fresnel lens shape.

The head-up display device according to the present embodiment can collect external light reflected by a second surface portion onto a facing portion. Furthermore, since the head-up display device has the thickness of a transparent cover, thickened from the side of the facing portion toward the side of an eye point, the head-up display device can relatively decrease the reflectance of external light reflected by a first surface portion and a second surface portion. This enables the head-up display device to relatively decrease the luminance of external light reflected inside the transparent cover. Even if the external light reflected inside the transparent cover reaches the eye point, the external light can be inhibited from being visually recognized as ghost. This enables the head-up display device to properly display a virtual image.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A head-up display device comprising:
a display unit that is provided in a vehicle and that displays a virtual image by reflecting display light emitted toward a reflection member capable of transmitting light toward a side of an eye point with the reflection member; and
a housing which has an opening facing the reflection member and to which the display unit is assembled,
wherein the display unit includes: a display instrument that is housed inside the housing and that emits the display light;
a reflection mirror that is housed inside the housing and that reflects enlarged display light obtained by enlarging the display light emitted from the display instrument toward the reflection member through the opening; and
a transparent cover that closes the opening and that transmits the enlarged display light reflected by the reflection mirror,
in the opening, a facing portion that blocks light is erected on a side opposite to the side of the eye point of the opening,
the transparent cover includes a curved portion having a curved shape,
the curved portion includes: a first surface portion located on a side of the reflection mirror; and a second surface portion that is located on a side opposite to the side of the reflection mirror and that collects external light onto the facing portion,
a thickness between the first surface portion and the second surface portion in a vertical direction is thickened from a side of the facing portion toward the side of the eye point in a range on the side of the eye point from a lowest point of the transparent cover in the vertical direction, and
the lowest point of the transparent cover enters the lower side of the facing portion.

2. The head-up display device according to claim 1, wherein the reflection mirror reflects external light, which has been reflected between the first surface portion and the second surface portion of the transparent cover, transmitted through the transparent cover, and emitted toward the reflection mirror, to a position different from a position of the opening.

3. The head-up display device according to claim 1, wherein the first surface portion has a free curved surface used for performing aberration correction on the enlarged display light reflected by the reflection mirror.

4. The head-up display device according to claim 2, wherein the first surface portion has a free curved surface used for performing aberration correction on the enlarged display light reflected by the reflection mirror.

5. The head-up display device according to claim 1,
wherein the display instrument directly emits the display light toward the reflection mirror, and
the reflection mirror reflects the enlarged display light obtained by enlarging the display light directly emitted from the display instrument toward the reflection member via the transparent cover.

6. The head-up display device according to claim 2,
wherein the display instrument directly emits the display light toward the reflection mirror, and
the reflection mirror reflects the enlarged display light obtained by enlarging the display light directly emitted from the display instrument toward the reflection member via the transparent cover.
